(19) United States
(12) Patent Application Publication
(10) Pub. No.: US 2025/0125089 A1
(43) Pub. Date: Apr. 17, 2025

(54) METHOD FOR PRODUCING RARE EARTH MAGNET AND RARE EARTH MAGNET

(71) Applicants: TOYOTA JIDOSHA KABUSHIKI KAISHA, Toyota-shi (JP); NICHIA CORPORATION, Anan-shi (JP)

(72) Inventors: Masaaki ITO, Anjo-shi (JP); Tomonori INUZUKA, Toyota-shi (JP); Motoki HIRAOKA, Toyota-shi (JP); Hisashi MAEHARA, Itano-gun (JP)

(73) Assignees: TOYOTA JIDOSHA KABUSHIKI KAISHA, Toyota-shi (JP); NICHIA CORPORATION, Anan-shi (JP)

(21) Appl. No.: 18/891,031

(22) Filed: Sep. 20, 2024

(30) Foreign Application Priority Data
Oct. 11, 2023 (JP) 2023-175934

(51) Int. Cl. H01F 41/02; C22C 38/00; C22C 38/12; C22C 38/14; H01F 1/059

(52) U.S. Cl. CPC H01F 41/0266; C22C 38/001; C22C 38/005; C22C 38/12; C22C 38/14; H01F 1/059; C22C 2202/02

(57) ABSTRACT

A method for producing a rare earth magnet that can improve magnetic properties by both increasing a density of a sintered body and suppressing strain of a magnetic phase. The method includes preparing a magnetic powder containing Sm, Fe, and N, preparing a modifier powder containing at least one of metallic zinc or a zinc alloy, mixing the magnetic powder and the modifier powder to obtain a mixed powder, performing compression molding on the mixed powder in a magnetic field to obtain a magnetic field molded body, and performing pressure sintering on the magnetic field molded body to obtain a sintered body. In the pressure sintering, the magnetic field molded body is pressed and sintered at a pressure of 500 MPa or more and 900 MPa or less and at a temperature of 360° C. or more and 390° C. or less for 1 hour or more and 24 hours or less.

### CROSS REFERENCE TO RELATED APPLICATIONS

The present application claims priority from Japanese patent application JP 2023-175934 filed on Oct. 11, 2023, the entire content of which is hereby incorporated by reference into this application.

### BACKGROUND

### Technical Field

The present disclosure relates to a method for producing a rare earth magnet and a rare earth magnet, and relates to a method for producing a rare earth magnet and a rare earth magnet in which a magnetic powder containing Sm, Fe, and N is sintered.

### Background Art

Conventionally, as a high-performance rare earth magnet, a SmCo-based rare earth magnet and a NdFeB-based rare earth magnet have been put into practical use. In recent years, a SmFeN-based rare earth magnet containing Sm, Fe, and N have been developed as a rare earth magnet other than these. The SmFeN-based rare earth magnet is produced using a SmFeN-based magnetic powder containing Sm, Fe, and N. As a method for producing the SmFeN-based rare earth magnet and the SmFeN-based rare earth magnet, for example, a method for producing a rare earth magnet that includes mixing the SmFeN-based magnetic powder and a modifier powder containing a zinc component to obtain a mixed powder, performing compression molding on the mixed powder in a magnetic field to obtain a magnetic field molded body, and performing pressure sintering on the magnetic field molded body to obtain a sintered body, and a rare earth magnet obtained by the method are known (JP 2023-077289 A).

### SUMMARY

In the method for producing the rare earth magnet described in JP 2023-077289 A, the SmFeN-based magnetic powder is reacted with the zinc component of the modifier powder during pressure sintering to form a modified phase on the surface of the magnetic powder, thereby suppressing demagnetization. Further, in order to increase a density of the sintered body for the purpose of improving magnetic properties, during pressure sintering, the magnetic field molded body is pressed and sintered at a pressure of 200 MPa or more and 1500 MPa or less and a temperature of 300° C. or more and 400° C. or less for 1 minute or more and 30 minutes or less. However, under these conventional pressure sintering conditions, the high pressure causes an accumulation of strain in a magnetic phase of the sintered body, and as a result, there is a possibility that an improvement in residual magnetization cannot be expected. In addition, the high temperature causes an excessive reaction between the SmFeN-based magnetic powder and the zinc component of the modifier powder to reduce a proportion of the magnetic phase in the sintered body. This and other reasons possibly cause the residual magnetization to decrease.

The present disclosure has been made in view of these points, and provides a method for producing a rare earth magnet that can improve magnetic properties by both increasing the density of the sintered body and suppressing the strain of the magnetic phase, and the rare earth magnet.

In order to solve the problem, a method for producing a rare earth magnet according to the present disclosure comprises preparing a magnetic powder containing Sm, Fe, and N (magnetic powder preparation step), preparing a modifier powder containing at least one of metallic zinc or a zinc alloy (modifier powder preparation step), mixing the magnetic powder and the modifier powder to obtain a mixed powder (mixing step), performing compression molding on the mixed powder in a magnetic field to obtain a magnetic field molded body (magnetic field molding step), and performing pressure sintering on the magnetic field molded body to obtain a sintered body (pressure sintering step). In the pressure sintering, the magnetic field molded body is pressed and sintered at a pressure of 500 MPa or more and 900 MPa or less and at a temperature of 360° C. or more and 390° C. or less for 1 hour or more and 24 hours or less.

In order to solve the problem, a rare earth magnet according to the present disclosure comprises a sintered body of a mixed powder containing a magnetic powder containing Sm, Fe, and N, and a modifier powder containing at least one of metallic zinc or a zinc alloy. A full width at half maximum of a diffraction peak of a (024) plane measured by an X-ray diffraction of the sintered body is 0.2 degrees or less, and a bulk density of the sintered body is 6.2 g/cm³ or more.

With the present disclosure, the magnetic properties can be improved by both increasing the density of the sintered body and suppressing the strain of the magnetic phase.

### BRIEF DESCRIPTION OF THE DRAWINGS

FIGS. 1A to 1D are schematic process drawings illustrating a method for producing a rare earth magnet according to one embodiment; and

FIGS. 2A and 2B are schematic process drawings illustrating the method for producing the rare earth magnet according to the one embodiment.

### DETAILED DESCRIPTION

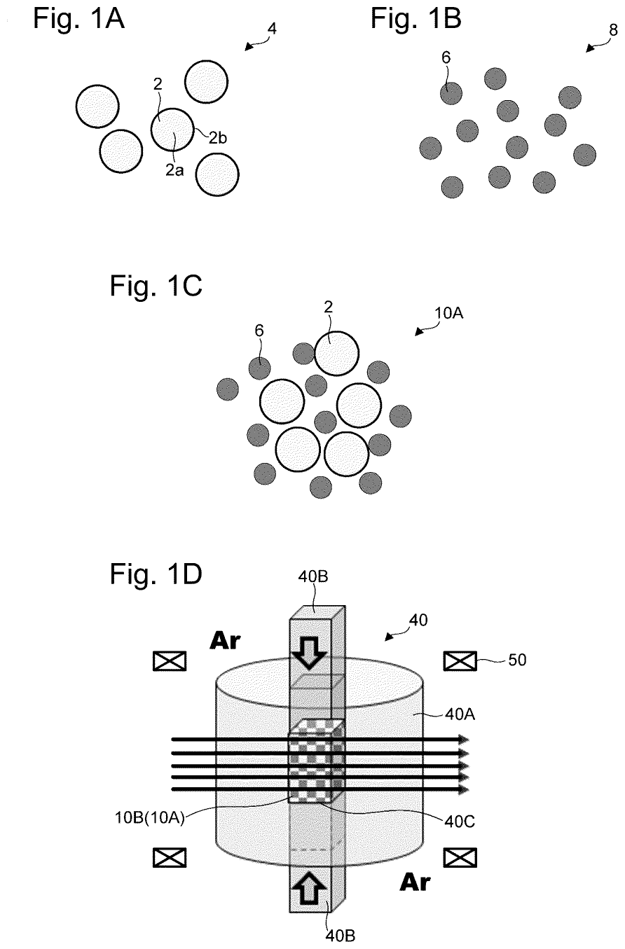

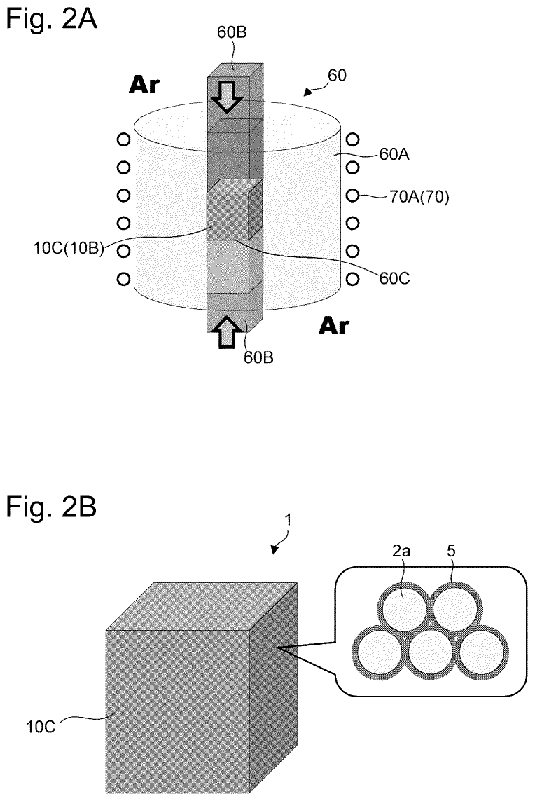

First, an outline of a method for producing a rare earth magnet and a rare earth magnet according to an embodiment will be described by exemplifying one embodiment. FIG. 1A to FIG. 2B are schematic process drawings illustrating a method for producing a rare earth magnet according to the one embodiment.

In the method for producing the rare earth magnet according to the one embodiment, first, as illustrated in FIG. 1A, a coated magnetic powder 4 is prepared (magnetic powder preparation step). The coated magnetic powder 4 contains a coated magnetic particle 2 including a magnetic particle 2a having a magnetic phase and a phosphoric acid coating 2b covering the surface of the magnetic particle 2a. The coated magnetic powder 4 is an anisotropic magnetic powder. The magnetic particle 2a contains Sm, Fe, and N. Next, as illustrated in FIG. 1B, as a modifier powder 8, a metallic zinc powder 8 containing a metallic zinc particle 6 is prepared (modifier powder preparation step). Next, as illustrated in FIG. 1C, the coated magnetic powder 4 and the metallic zinc powder 8 are mixed to obtain a mixed powder 10A (mixing step).

Next, as illustrated in FIG. 1D, using a molding die 40 and electromagnetic coils 50, the mixed powder 10A is subjected to compression molding in a magnetic field (magnetic field molding) to obtain a magnetic field molded body 10B (magnetic field molding step). The molding die 40 includes a die 40A and punches 40B. The die 40A has a cavity 40C, and the punches 40B slide inside the cavity 40C. The electromagnetic coils 50 are arranged on both sides of the periphery of the die 40A in a direction perpendicular to the sliding direction (open arrow direction) of the punches 40B. Magnetic field molding is performed in a nitrogen gas atmosphere. At this time, first, the mixed powder 10A is stored in the cavity 40C of the die 40A in a nitrogen gas atmosphere. Subsequently, while the electromagnetic coils 50 are applying a magnetic field in a direction (arrow direction) perpendicular to the sliding direction of the punches 40B to the mixed powder 10A in the cavity 40C of the die 40A, the punches 40B are moved to perform compression molding on the mixed powder 10A.

Next, as illustrated in FIG. 2A, using a sintering die 60 and a heater 70, the magnetic field molded body 10B is pressed and sintered to obtain a sintered body 10C (pressure sintering step). The sintering die 60 includes a die 60A and punches 60B. The die 60A has a cavity 60C, and the punches 60B slide inside the cavity 60C. The heater 70 includes high-frequency induction coils 70A arranged on the periphery of the die 60A in a direction perpendicular to the sliding direction (open arrow direction) of the punches 60B. Pressure sintering is performed in an argon gas atmosphere. At this time, first, the magnetic field molded body 10B is transferred from the die 40A of the molding die 40 into the cavity 60C of the die 60A of the sintering die 60. Subsequently, while the high-frequency induction coils 70A are heating the magnetic field molded body 10B in the cavity 60C of the die 60A, the punches 60B are moved to press the magnetic field molded body 10B. The magnetic field molded body 10B is thus pressed and sintered at a pressure of 500 MPa or more and 900 MPa or less and at a temperature of 360° C. or more and 390° C. or less for 1 hour or more and 24 hours or less.

Next, although not shown, the punches 60B of the sintering die 60 are moved, and the sintered body 10C is taken out from inside the cavity 60C of the die 60A. Thus, as illustrated in FIG. 2B, as the rare earth magnet according to the one embodiment, a rare earth magnet 1 including the sintered body 10C is produced. In the rare earth magnet 1, inside the sintered body 10C, the magnetic particles 2a are bonded by a modified phase 5 in which an α-Fe phase of the surface portion of the magnetic particles 2a and the zinc component of the modifier powder 8 are alloyed. In an X-ray diffraction pattern measured by an X-ray diffraction on the surface of the sintered body 10C, a full width at half maximum of a diffraction peak of a (024) plane in a crystalline structure of the magnetic phase in the magnetic particles 2a of the sintered body 10C is 0.2 degrees or less. A bulk density of the sintered body 10C is 6.2 g/cm³ or more.

In the method for producing the rare earth magnet according to the one embodiment, in the pressure sintering step, the magnetic field molded body is pressed and sintered at a pressure of 500 MPa or more and 900 MPa or less and at a temperature of 360° C. or more and 390° C. or less for 1 hour or more and 24 hours or less. By thus performing pressure sintering under conditions of a lower pressure and a longer time than conventional ones, the bulk density of the sintered body can be 6.2 g/cm³ or more, and the full width at half maximum of the diffraction peak of the (024) plane in the crystalline structure of the magnetic phase in the magnetic particles of the sintered body can be 0.2 degrees or less. That is, it is possible to achieve both increasing the density of the sintered body of the rare earth magnet according to the one embodiment and suppressing the strain of the magnetic phase of the sintered body of the rare earth magnet according to the one embodiment. This allows improving the magnetic properties such as residual magnetization of the rare earth magnet according to the one embodiment. Subsequently, the method for producing the rare earth magnet and the rare earth magnet according to the embodiment will be described in detail.

### 1. Method for Producing Rare Earth Magnet

The method for producing the rare earth magnet includes a magnetic powder preparation step, a modifier powder preparation step, a mixing step, a magnetic field molding step, and a pressure sintering step.

### (1) Magnetic Powder Preparation Step

In the magnetic powder preparation step, a magnetic powder containing Sm, Fe, and N (hereinafter sometimes abbreviated as “SmFeN-based magnetic powder” or “magnetic powder”) is prepared. The SmFeN-based magnetic powder is not particularly limited as long as the magnetic powder contains magnetic particles having a magnetic phase and containing Sm, Fe, and N. The SmFeN-based magnetic powder may be a common magnetic powder, and is usually an anisotropic magnetic powder. The SmFeN-based magnetic powder may be, for example, an uncoated magnetic powder in which the surface of the magnetic particle is not covered with a phosphoric acid coating, or may be a coated magnetic powder containing a coated magnetic particle including the magnetic particle and the phosphoric acid coating covering the surface of the magnetic particle. The SmFeN-based magnetic powder is a coated magnetic powder in some embodiments. This is because the phosphoric acid coating can suppress deterioration of the magnetic particles due to oxidation in the producing process of the magnet.

The magnetic phase of the magnetic particles in the magnetic powder is not particularly limited as long as it contains Sm, Fe, and N, and may be a common magnetic phase. However, the magnetic phase is a phase at least partially having a crystalline structure of at least one of Th₂Zn₁₇ type or Th₂Ni₁₇ type. The magnetic phase is not particularly limited, and includes a phase further having a ThCu₇-type crystalline structure or the like. Sm is samarium, Fe is iron, and N is nitrogen. Further, Th is thorium, Zn is zinc, Ni is nickel, Tb is terbium, and Cu is copper. The rare earth magnet develops magnetization from the magnetic phase of the magnetic particles in the magnetic powder.

The magnetic particles in the magnetic powder are not particularly limited as long as the magnetic particles have the above-described magnetic phase and contain Sm, Fe, and N, and may have a general composition. Examples of the magnetic particles include particles further containing one or more kinds of elements selected from a group consisting of La. W, and R (R is at least one kind of element selected from a group consisting of Ti, Ba, Sr, and Co), in addition to Sm, Fe, and N, and among them, particles in which the composition of the magnetic particles is represented by the following general formula (1) are used in some embodiments.

SmᵥFe_{(100-v-w-x-y-z)}N_{w}LaₓW_{y}R_{z} (1)

(The subscripts v, w, x, y, and z in the formula satisfy the conditions of 3≤v≤30, 3≤w≤15, 0≤x≤0.5, 0≤y≤2.5, and 0≤z≤0.3.)

In the above general formula (1), v is defined as 3 or more and 30 or less because when v is less than 3, the unreacted portion (α-Fe phase) of the iron component may be separated to decrease the coercive force of the magnetic powder. This is because when v exceeds 30, the Sm element may be deposited, causing the magnetic powder to become unstable in the air and decreasing the residual magnetization. w is defined as 3 or more and 15 or less is because when w is less than 3, almost no coercive force can be developed, and when w exceeds 15, nitrides of Sm and iron themselves may be generated. x is 0 or more and 0.5 or less, and is 0.05 or more and 0.5 or less in some embodiments. When x is less than 0.05, the effect of addition is insufficient, and when x exceeds 0.5, nitrides of Sm and iron themselves may be generated, decreasing the magnetization. y is 0 or more and 2.5 or less, and is 0.05 or more and 2.5 or less in some embodiments. When y is less than 0.05, the effect of addition is insufficient, and when y exceeds 2.5, nitrides of Sm and iron themselves may be generated, decreasing the magnetization. z is 0 or more and 0.3 or less, and is 0.0001 or more and 0.3 or less in some embodiments. When z is less than 0.0001, the effect of addition is insufficient, and nitrides of Sm and iron themselves may be generated, decreasing the magnetization.

The content of Sm in the magnetic particles of the magnetic powder may be, for example, 3 mass % or more and 30 mass % or less, and may be 20 mass % or more and 25 mass % or less. The content of N in the magnetic particles of the magnetic powder may be, for example, 3 mass % or more and 15 mass % or less, and may be 3.3 mass % or more and 3.5 mass % or less. When the content of N is excessively high, overnitridation occurs, and when the content of N is excessively low, nitridation becomes insufficient, both of which tend to result in reduced magnetic properties. The content of Fe in the magnetic particles of the magnetic powder is an amount obtained by subtracting the content of elements other than Fe from the content of all the elements contained in the magnetic particles of the magnetic powder.

When the magnetic particles of the magnetic powder further contain La, the content of La may be, for example, 0.1 mass % or more and 5 mass % or less, and may be 0.15 mass % or more and 1 mass % or less, in terms of residual magnetization. When the magnetic particles of the magnetic powder further contain W, the content of W may be, for example, 0.1 mass % or more and 5 mass % or less, and may be 0.15 mass % or more and 1 mass % or less, in terms of coercive force. When the magnetic particles of the magnetic powder further contain R, the content of R may be, for example, 1.0 mass % or less, and may be 0.5 mass % or less, in terms of temperature properties.

A cumulative 50% particle size D₅₀ (median diameter) in the volume-based particle size distribution of the magnetic powder is not particularly limited and may be a common one. When the magnetic powder is a coated magnetic powder, the cumulative 50% particle size D₅₀ may be, for example, 2 μm or more and 5 μm or less, and may be 2.5 μm or more and 4.5 μm or less. When the D₅₀ of the magnetic powder is too small, the amount of the magnetic powder filled in the magnet may be small, decreasing the magnetization. On the other hand, when the D₅₀ of the magnetic powder is too large, the coercive force of the magnet tends to decrease. The D₅₀ of the magnetic powder when the magnetic powder is an uncoated magnetic powder is also similar to the D₅₀ of the magnetic powder when the magnetic powder is the coated magnetic powder. The D₅₀ of the magnetic powder can be determined by, for example, measuring with a laser diffraction particle size analyzer or the like.

The coated magnetic powder is obtained by treating a magnetic powder containing magnetic particles having a magnetic phase containing Sm, Fe, and N with phosphoric acid. The phosphoric acid treatment of the magnetic powder forms a phosphoric acid coating, which is a passive film having P—O bonds, on the surface of the magnetic particles of the magnetic powder. In the phosphoric acid treatment, the magnetic powder is reacted with a phosphoric acid treatment agent of, for example, a phosphate such as orthophosphoric acid and the like. In this case, a method such as adding the magnetic powder to a phosphoric acid solution in which the phosphoric acid treatment agent is dissolved in water, an organic solvent, or the like is used. When the magnetic powder is subjected to the phosphoric acid treatment, the magnetic powder may be dried under ordinary pressure or under vacuum after the phosphoric acid treatment. This is because the coercive force of the magnet can be improved by chemically bonding the phosphoric acid coating to the magnetic particles. The drying temperature may be 140° C. or more. The thickness of the phosphoric acid coating is not particularly limited and may be a typical thickness. The thickness of phosphoric acid coating is, for example, 1 nm or more and 50 nm or less, and 5 nm or more and 30 nm or less in some embodiments.

### (2) Modifier Powder Preparation Step

In the modifier powder preparation step, a modifier powder containing at least one of metallic zinc or a zinc alloy is prepared. The modifier powder modifies and binds the magnetic particles of the magnetic powder with the zinc component.

The modifier powder is not particularly limited as long as it is a powder as described above, and may be a common modifier powder. The modifier powder may be, for example, a metallic zinc powder containing metallic zinc particles or a zinc alloy powder containing zinc alloy particles.

The zinc alloy is obtained by alloying Zn with another element (M²) (hereinafter, sometimes referred to as “Zn-M²”). Here, Zn is zinc, and M² is another element other than zinc. M² is not particularly limited as long as it can be alloyed with Zn, and may be a common element. M² may include, for example, one or more kinds of elements selected from an element (hereinafter, sometimes abbreviated as “melting point lowering element”) that lowers the melting start temperature of the zinc alloy to below the melting point of Zn, an inevitable impurity element, and the like. This is because the sinterability in pressure sintering is improved. Examples of the melting point lowering element include an element capable of forming a eutectic alloy with Zn, and specific examples thereof include one or more kinds of elements such as Sn, Mg, Al, and the like. Sn is tin, Mg is magnesium, and Al is aluminum. M² may further include, in addition to the melting point lowering element, the inevitable impurity element, and the like, one or more kinds of elements that do not interfere with the melting point lowering action by the melting point lowering element or the properties of the magnet. The inevitable impurity element means an impurity element whose inclusion in the modifier powder cannot be avoided such as an impurity and the like contained in raw materials of the modifier powder, as well as an impurity element that requires significant cost to avoid inclusion in the modifier powder. The mole ratio of Zn and M² in Zn-M² is not particularly limited and may be a common mole ratio, and may be appropriately determined so as to give an appropriate sintering temperature at pressure sintering. The mole ratio of M² in Zn-M² is, for example, 0.05 or more, and may be 0.10 or more, particularly 0.20 or more. The mole ratio of M² in Zn-M² is, for example, 0.90 or less, and may be 0.80 or less, particularly 0.70 or less, 0.60 or less, 0.50 or less, 0.40 or less, or 0.30 or less.

The total content of metallic zinc and zinc alloy in the modifier powder is not particularly limited and may be a common content. For example, the total content is 90 mass % or more and 100 mass % or less, and may be 95 mass % or more and 100 mass % or less. In addition to metallic zinc and zinc alloy, the modifier powder may optionally contain a substance having at least one of a binder function, a modification function, or other functions (such as a function of improving corrosion resistance) as long as the effect of the present disclosure is not impaired. The content of such a substance in the modifier powder is, for example, the content of a portion excluding metallic zinc and zinc alloy from the entire modifier powder.

A cumulative 50% particle size D₅₀ (median diameter) in the volume-based particle size distribution of the modifier powder is not particularly limited, and is, for example, 0.1 μm or more, and may be 0.5 μm or more, particularly 1 μm or more. The D₅₀ of the modifier powder is, for example, 4 μm or less, and may be 2 μm or less, particularly 1 μm or less. The D₅₀ of the modifier powder can be determined by, for example, measuring with a laser diffraction particle size analyzer or the like.

### (3) Mixing Step

In the mixing step, a mixed powder is obtained by mixing the magnetic powder and the modifier powder. The content of the modifier powder in the mixed powder is not particularly limited and may be a common content. In terms of residual magnetization, for example, the content may be 2 pts·mass (2 mass %) or more and 20 pts·mass (20 mass %) or less with respect to 100 pts·mass (100 mass %) of the SmFeN-based magnetic powder, and may be 5 pts·mass (5 mass %) or more and 10 pts·mass (10 mass %) or less with respect to 100 pts·mass (100 mass %) of the SmFeN-based magnetic powder.

The mixing method of the magnetic powder and the modifier powder is not particularly limited and may be a common method. Examples of the mixing method include a method using a mortar, a muller wheel mixer, an agitator mixer, a mechanofusion, a V-type mixer, a ball mill, or the like.

### (4) Magnetic Field Molding Step

In the magnetic field molding step, a magnetic field molded body is obtained by performing compression molding on the mixed powder in a magnetic field (hereinafter, sometimes abbreviated as “magnetic field molding”). An orientation is imparted to the magnetic field molded body. This imparts anisotropy to the rare earth magnet and improves the residual magnetization.

The method of magnetic field molding is not particularly limited and a common method may be used. Examples of the method include a method such as performing compression molding on the mixed powder in a molding die while applying a magnetic field to the mixed powder with a magnetic field generator disposed around the molding die such as a metallic mold. Examples of the magnetic field generator include a device such as an electromagnetic coil that applies a static magnetic field, a device that applies a pulsed magnetic field using an alternating current, and the like. The atmosphere in which the magnetic field molding is performed is not particularly limited, and may be, for example, an inert gas atmosphere such as an argon gas atmosphere and a nitrogen gas atmosphere. This is because the inert gas atmosphere can suppress oxidation of the magnetic field molded body. The molding pressure of the magnetic field molding is, for example, 10 MPa or more, and may be 20 MPa or more, particularly 30 MPa or more, 50 MPa or more, or 100 MPa or more. The molding pressure is, for example, 1500 MPa or less, and may be 1000 MPa or less, particularly 500 MPa or less, 200 MPa or less, or 100 MPa or less. The application time of the molding pressure is, for example, 0.5 minutes or more, and may be 1 minute or more, particularly 3 minutes or more. The application time of the molding pressure is, for example, 10 minutes or less, and may be 7 minutes or less, particularly 5 minutes or less. The magnitude of the magnetic field of the magnetic field molding is, for example, 500 kA/m or more, and may be 1000 kA/m or more, particularly 1500 kA/m or more, or 1600 kA/m or more. The magnitude of the magnetic field is, for example, 20000 kA/m or less, and may be 15000 kA/m or less, particularly 10000 kA/m or less, 5000 kA/m or less, 3000 kA/m or less, or 2000 kA/m or less.

### (5) Pressure Sintering Step

In the pressure sintering step, a sintered body is obtained by performing pressure sintering on the magnetic field molded body (hereinafter, sometimes abbreviated as “pressure sintering”). The method of pressure sintering is not particularly limited and a common method may be used. Examples of the method include a method such as heating a magnetic field molded body with a heating device while pressing the magnetic field molded body with a molding die such as a metallic mold. Examples of the heating device include a heater including high-frequency induction coils arranged on the periphery of the molding die, or the like. The atmosphere in which the pressure sintering is performed is not particularly limited, and may be, for example, an inert gas atmosphere such as an argon gas atmosphere and a nitrogen gas atmosphere. This is because the inert gas atmosphere can suppress oxidation of the sintered body.

In the pressure sintering, the magnetic field molded body is pressed and sintered at a pressure of 500 MPa or more and 900 MPa or less and at a temperature of 360° C. or more and 390° C. or less for 1 hour or more and 24 hours or less. This allows both increasing the density of the sintered body of the rare earth magnet and suppressing the strain of the magnetic phase.

When the pressure for the pressure sintering is 500 MPa or more and 900 MPa or less, it is possible to increase the density of the sintered body and suppress the strain of the magnetic phase. When the temperature for the pressure sintering is 360° C. or more and 390° C. or less, it is possible to form a modified phase, which is an Fe—Zn alloy phase in which the α-Fe phase of the surface portion of the magnetic particles and the zinc component of the modifier powder on the surface of the magnetic particles are alloyed, and demagnetization can be suppressed. In addition, it is possible to increase the density of the sintered body and suppress the strain of the magnetic phase. When the temperature is less than 360° C., there is a possibility that the modified phase cannot be formed. When the temperature exceeds 390° C., the magnetic powder and the zinc component of the modifier powder excessively react with each other to reduce a proportion of the magnetic phase in the sintered body, increasing the strain of the magnetic phase. In addition, various phases such as an alloy phase different from the modified phase and the α-Fe phase are generated on the surface of the magnetic particles, causing the demagnetization. When the time of the pressure sintering is 1 hour or more and 24 hours or less, it is possible to increase the density of the sintered body and suppress the strain of the magnetic phase. When the time is less than 1 hour, there is a possibility that the density of the sintered body cannot be increased.

### (6) Method for Producing Rare Earth Magnet

The method for producing the rare earth magnet is not particularly limited as long as it is a method including the above-described steps. For example, a method may be used in which the magnetic powder is a coated magnetic powder containing a coated magnetic particle including a magnetic particle having a magnetic phase containing Sm, Fe, and N and a phosphoric acid coating covering the surface of the magnetic particle, the modifier powder is a metallic zinc powder, and the content of the modifier powder in the mixed powder is 5 pts·mass (5 mass %) or more and 10 pts·mass (10 mass %) or less with respect to 100 pts·mass (100 mass %) of the magnetic powder. This easily achieves the full width at half maximum of the diffraction peak of the (024) plane measured by the X-ray diffraction of the sintered body of 0.2 degrees or less and the bulk density of the sintered body of 6.2 g/cm³ or more. That is, this easily achieves both increasing the density of the sintered body of the rare earth magnet and suppressing the strain of the magnetic phase. As a method for producing the rare earth magnet, for example, a method may be used in which the cumulative 50% particle size D₅₀ in the volume-based particle size distribution of the magnetic powder is 2 μm or more and 5 μm or less, and the cumulative 50% particle size D₅₀ in the volume-based particle size distribution of the modifier powder is 0.1 μm or more and 4 μm or less. This easily achieves both increasing the density of the sintered body of the rare earth magnet and suppressing the strain of the magnetic phase.

### 2. Rare Earth Magnet

The rare earth magnet includes the sintered body of the mixed powder containing the magnetic powder containing Sm, Fe, and N, and the modifier powder containing at least one of metallic zinc or a zinc alloy. The full width at half maximum of the diffraction peak of the (024) plane measured by the X-ray diffraction of the sintered body is 0.2 degrees or less, and the bulk density of the sintered body is 6.2 g/cm³ or more. The rare earth magnet is not particularly limited as long as it is the above-described rare earth magnet. For example, the rare earth magnet may be produced by the method for producing the rare earth magnet described in “1. Method for Producing Rare Earth Magnet” above.

The magnetic powder contained in the mixed powder used for the sintered body of the rare earth magnet is similar to the SmFeN-based magnetic powder described in “1. Method for Producing Rare Earth Magnet (1) Magnetic Powder Preparation Step” above. The modifier powder contained in the mixed powder is similar to the modifier powder described in “1. Method for Producing Rare Earth Magnet (2) Modifier Powder Preparation Step” above. The mixed powder is similar to the mixed powder described in “1. Method for Producing Rare Earth Magnet (3) Mixing Step” above. The sintered body of the rare earth magnet is not particularly limited as long as it is the above-described sintered body, and for example, a sintered body of the magnetic field molded body of the mixed powder may be used.

### EXAMPLES

The following further specifically describes the method for producing the rare earth magnet and the rare earth magnet according to the embodiment with Examples and Comparative Examples.

### Example 1

An example of the method for producing the rare earth magnet according to the above-described one embodiment was performed. First, a coated magnetic powder was prepared (magnetic powder preparation step). The coated magnetic powder contains a coated magnetic particle including a magnetic particle having a magnetic phase and a phosphoric acid coating covering the surface of the magnetic particle. The magnetic particles contain Sm (22.3 mass %), Fe (71.5 mass %), N (3.3 mass %), La (0.48 mass %), W (0.51 mass %), and Ti (0.17 mass %). The coated magnetic powder is obtained by treating the magnetic powder containing the magnetic particles with phosphoric acid. In the phosphoric acid treatment in this case, first, the magnetic powder was put into pure water to obtain a slurry, and then a phosphoric acid solution was put into the slurry such that 1 mass % of PO₄ of the phosphoric acid (H₃PO₄) was added to the solid content of the magnetic particles. Subsequently, the slurry was stirred for 5 minutes and subjected to a solid-liquid separation, and then vacuum drying was performed at 190° C. for 3 hours. As a result, a phosphoric acid coating, which is a passive film having P—O bonds, was formed on the surface of the magnetic particles. A D₅₀ of the coated magnetic powder was 3.00 μm.

Next, as a modifier powder, a metallic zinc powder containing metallic zinc particles (purity of metallic zinc: 99.9 mass %, D₅₀: 0.5 μm) was prepared (modifier powder preparation step). Next, the coated magnetic powder and the metallic zinc powder were blended such that the content of the metallic zinc powder was 7.5 mass %, and then the coated magnetic powder and the metallic zinc powder were mixed using a vibration mill to obtain a mixed powder (mixing step).

Next, the mixed powder was subjected to compression molding in a magnetic field (magnetic field molding) to obtain a magnetic field molded body (magnetic field molding step). The magnetic field molding was performed in a nitrogen gas atmosphere, the molding pressure for the magnetic field molding was 50 MPa, the application time of the molding pressure for the magnetic field molding was 1 minute, and the magnitude of the magnetic field of the magnetic field molding was 1600 kA/m. The magnetization easy axes of the magnetic particles of the magnetic field molded body are aligned by the magnetic field orientation in the magnetic field molding.

Next, the magnetic field molded body was pressed and sintered to obtain a sintered body (pressure sintering step). The pressure sintering was performed in an argon gas atmosphere of 97000 Pa, and the pressure for the pressure sintering (pressing pressure) was 900 MPa, the temperature for the pressure sintering (pressing temperature) was 390° C., and the pressure sintering time (pressing time) was 24 hours. Thus, a rare earth magnet including the sintered body was produced. The production conditions including the composition of the mixed powder and the conditions for the pressure sintering are shown in Table 1 below.

### Examples 2 to 4 and Comparative Examples 1 to 9

The pressure, temperature, and time of the pressure sintering were as shown in Table 1 below. Except for these points, a rare earth magnet including a sintered body was produced in the same manner as in Example 1.

### [Evaluation of Full Width at Half Maximum of Diffraction Peak of (024) Plane in Sintered Body]

An X-ray diffraction measurement was performed on the surface perpendicular to the magnetization easy axis of the sintered body of the rare earth magnet in each of Examples 1-4 and Comparative Examples 1-9, and the X-ray diffraction pattern was measured. The measurement was performed under conditions using a CuKα ray under an inert atmosphere. Then, a full width at half maximum [degree] of a diffraction peak of a (024) plane in a crystalline structure of a magnetic phase of the magnetic particles of the sintered body was obtained from the X-ray diffraction pattern. The results are shown in Table 1 below.

### [Evaluation of Bulk Density]

A weight and volume of the sintered body of the rare earth magnet in each of Examples 1 to 4 and Comparative Examples 1 to 9 were measured. Then, a bulk density [g/cm³] of the sintered body was calculated from the weight and volume (calculated from the dimension) of the sintered body of the rare earth magnet. The results are shown in Table 1 below.

### [Evaluation of Magnetic Properties]

The magnetic properties of the rare earth magnet in each of Examples 1-4 and Comparative Examples 1-9 were evaluated. At this time, at room temperature, the rare earth magnet of each example was pulse magnetized in a magnetizing magnetic field of 6400 kA/m and a residual magnetization Br [T] was measured by means of a VSM (vibrating sample magnetometer) having a maximum magnetic field of 1600 kA/m. The results are shown in Table 1 below.

TABLE 1

| | Production Conditions | | | | | | | | | |
|---|---|---|---|---|---|---|---|---|---|---|
| | Composition of Mixed Powder | | | | | | Evaluation Results | | | |
| | | Present or | | | | | Full Width | | | |
| | | Absent of | | | | | at Half | | | |
| | | Phosphoric | | | | | Maximum | | | |
| | D₅₀ of | Acid | Content of | Conditions for Pressure Sintering | | | of (024) | | | |
| | Magnetic | Coating on | Metallic Zinc | Pressing | Pressing | Pressing | Plane Diffraction | Bulk | | |
| | Powder | Magnetic | Powder | Pressure | Temperature | Time | Peak | Density | Br | Reason for |
| No | [μm] | Powder | [mass %] | [MPa] | [° C.] | [hours] | [degrees] | [g/cm³] | [T] | Decrease in Br |
| Example 1 | 3.00 | Present | 7.5 | 900 | 390 | 24 | 0.199 | 6.925 | 1.0000 | |
| Example 2 | | | | 900 | 360 | 1 | 0.125 | 6.440 | 0.98 | |
| Example 3 | | | | 500 | 390 | 24 | 0.143 | 6.219 | 0.911 | |
| Example 4 | | | | 500 | 360 | 1 | 0.137 | 6.201 | 0.901 | |
| Comparative | | | | 1000 | 390 | 24 | 0.273 | 6.940 | 0.891 | Strain Increase |
| Example 1 | | | | | | | | | | |
| Comparative | | | | 1000 | 360 | 1 | 0.231 | 6.930 | 0.895 | Strain Increase |
| Example 2 | | | | | | | | | | |
| Comparative | | | | 400 | 390 | 24 | 0.142 | 6.091 | 0.884 | Density Decrease |
| Example 3 | | | | | | | | | | |
| Comparative | | | | 400 | 360 | 1 | 0.137 | 5.621 | 0.889 | Density Decrease |
| Example 4 | | | | | | | | | | |
| Comparative | | | | 900 | 400 | 1 | 0.271 | 6.941 | 0.893 | Strain Increase |
| Example 5 | | | | | | | | | | |
| Comparative | | | | 900 | 350 | 24 | 0.224 | 6.412 | 0.852 | Strain Increase |
| Example 6 | | | | | | | | | | |
| Comparative | | | | 500 | 400 | 24 | 0.205 | 6.305 | 0.856 | Strain Increase |
| Example 7 | | | | | | | | | | |
| Comparative | | | | 500 | 350 | 1 | 0.042 | 5.514 | 0.848 | Density Decrease |
| Example 8 | | | | | | | | | | |
| Comparative | | | | 900 | 390 | 25 | 0.231 | 6.936 | 0.8970 | Strain Increase |
| Example 9 | | | | | | | | | | |

*Values out of range of the present disclosure are underlined.

### Discussion

As shown in Table 1 above, in Examples 1 to 4, the production conditions of the rare earth magnet are set such that the pressure for the pressure sintering (pressing pressure) is 500 MPa or more and 900 MPa or less, the temperature for the pressure sintering (pressing temperature) is 360° C. or more and 390° C. or less, and the pressure sintering time (pressing time) is 1 hour or more and 24 hours or less. As a result, the evaluation results of the rare earth magnets showed that the bulk density of the sintered body was 6.2 g/cm³ or more, and the full width at half maximum of the diffraction peak of the (024) plane of the crystalline structure of the magnetic phase of the sintered body was 0.2 degrees or less. This resulted in the residual magnetization Br of 0.9 T or more.

On the other hand, in Comparative Examples 1 and 2, the full width at half maximum exceeded 0.2 degrees. This may be because the pressure exceeding 900 MPa caused a large deformation of the magnetic particles to decrease the crystallinity of the magnetic phase. In Comparative Examples 3 and 4, the bulk density was lower than 6.2 g/cm³. This may be because the pressure less than 500 MPa failed to increase the density of the sintered body. In Comparative Example 5, the full width at half maximum exceeded 0.2 degrees. This may be because the temperature exceeding 390° C. caused the large deformation of the magnetic particles to decrease the crystallinity of the magnetic phase. In Comparative Example 6, the full width at half maximum exceeded 0.2 degrees. This may be because the temperature less than 360° C. under the condition of the pressure of 900 MPa maintained the hardness of the magnetic particles and increased the pressing force between the magnetic particles, resulting in a decrease in the crystallinity of the magnetic phase. In Comparative Example 7, the full width at half maximum exceeded 0.2 degrees. This may be because the temperature exceeding 390° C. caused an excessive reaction between the magnetic powder and the zinc component, increasing the strain of the magnetic phase. In Comparative Example 8, the bulk density was lower than 6.2 g/cm³. This may be because the temperature less than 360° C. under the condition of the pressure of 500 MPa failed to increase the density of the sintered body. In Comparative Example 9, the full width at half maximum exceeded 0.2 degrees. This may be because the time exceeding 24 hours caused the large deformation of the magnetic particles to decrease the crystallinity of the magnetic phase.

While the embodiments of the present disclosure have been described in detail above, the present disclosure is not limited thereto, and can be subjected to various kinds of changes in design without departing from the spirit of the present disclosure described in the claims.

### DESCRIPTION OF SYMBOLS

1 Rare earth magnet
2 Coated magnetic particle
2a Magnetic particle
2b Phosphoric acid coating
4 Coated magnetic powder
5 Modified phase
6 Metallic zinc particle
8 Metallic zinc powder (modifier powder)
10A Mixed powder
10B Magnetic field molded body
10C Sintered body

What is claimed is:

1. A method for producing a rare earth magnet, comprising:
preparing a magnetic powder containing Sm, Fe, and N;
preparing a modifier powder containing at least one of metallic zinc or a zinc alloy;
mixing the magnetic powder and the modifier powder to obtain a mixed powder;
performing compression molding on the mixed powder in a magnetic field to obtain a magnetic field molded body; and
performing pressure sintering on the magnetic field molded body to obtain a sintered body,
wherein in the pressure sintering, the magnetic field molded body is pressed and sintered at a pressure of 500 MPa or more and 900 MPa or less and at a temperature of 360° C. or more and 390° C. or less for 1 hour or more and 24 hours or less.

2. A rare earth magnet comprising
a sintered body of a mixed powder containing a magnetic powder containing Sm, Fe, and N, and a modifier powder containing at least one of metallic zinc or a zinc alloy,
wherein a full width at half maximum of a diffraction peak of a (024) plane measured by an X-ray diffraction of the sintered body is 0.2 degrees or less, and
wherein a bulk density of the sintered body is 6.2 g/cm³ or more.
